(19) United States
(12) Patent Application Publication
(10) Pub. No.: US 2017/0214672 A1
(43) Pub. Date: Jul. 27, 2017

(54) Universal Physical Access Control System and Method

(71) Applicants: Bassem Alhalabi, Boca Raton, FL (US); Clyde Carryl, Boca Raton, FL (US)

(72) Inventors: Bassem Alhalabi, Boca Raton, FL (US); Clyde Carryl, Boca Raton, FL (US)

(21) Appl. No.: 15/004,997

(22) Filed: Jan. 24, 2016

(51) Int. Cl. H04L 29/06; H04L 9/08; H04L 29/08

(52) U.S. Cl. CPC H04L 63/08; H04L 67/10; H04L 67/125; H04L 63/10; H04L 63/06; H04L 9/083

(57) ABSTRACT

A communication protocol system, like a universal physical access control system, regulates access and controlling behavior of a plurality of resources. The system allows a user to master universal access and control of the resources through operation of at least one universal controller. The user utilizes a user interface to transmit commands to the universal controller. The universal controller communicates the commands to at least one local data controller. The local data controller integrates into the local device controller for actuation of the resources. The user controls the resources from multiple locations onsite or remotely, and the resources can be located at multiple locations. A secure key server authenticates transmission of the command. Multiple modules provide operational phases, and include: a resource registration module, a child node addition module, a child node deletion module, an access rights modification module, a user deletion module, and a resource actuation module.

### FIELD OF THE INVENTION

The present invention relates generally to a communication protocol system and method for accessing and controlling multiple resources with at least one universal device. More so, a universal physical access control system and method enables a user to have universal access and control of a plurality of resources from multiple locations through operation of at least one universal device located at multiple locations.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, physical access systems control is the selective restriction of access to a place or other resource. The act of accessing may mean consuming, entering, or using. Often, permission to access a resource is called authorization.

It is known that a wide variety of producers fabricate physical access systems that are wired, wireless, local, remote, mobile, web-based, and any combination thereof. These physical access systems enable remote or onsite access and control of the behavior of a resource, such as a physical device.

Generally, numerous companies produce physical devices to satisfy a wide variety of applications, from simple consumer to large-scale industrial. However, there is no single manufacture who has a complete line of all possible physical devices. Nor is there compatibility between physical devices from various manufacturers.

With the recent rapid increase in the number of physical facilities and structures that need to be protected by restricting physical access to them, there has been an explosion in the number and type of physical access control systems being deployed to protect them. However, these systems are quite different from each other and there is no common standard that provides for interoperability between the various systems.

It is known that the number and types of access devices being employed has grown steadily, but the systems in which they are being used are physically and technologically incompatible with each other. Consequently, there is renewed interest within the research and commercial market communities in developing a common universal system providing physical resource access protection regardless of the type of physical resource and where it is located.

Other proposals have involved physical access control systems. The problem with these systems is that each physical device requires its own controller, and the user cannot operate the controllers from multiple places. Even though the above cited physical access control systems meets some of the needs of the market, a universal physical access control system and method enables a user to have universal access and control of a plurality of resources from multiple locations through operation of at least one universal device located at multiple locations is still desired.

### SUMMARY OF THE INVENTION

The present invention is directed to a communication protocol system, such as a universal physical access control system (UPACS). A method for operating the communication protocol system is also disclosed. In some embodiments, the communication protocol system, hereafter “system”, enables a user to master universal access and control of a plurality of resources through operation of at least one universal controller. The user may utilize a user interface to input instructions into the universal controller. The universal controller communicates the instructions to at least one local data controller that integrates into the resources. The user may control the resources from multiple locations, and the resources may also be located at multiple locations.

In some embodiments, the system enables a user to access and control a plurality of resources. The user can control the resources through manipulation of at least one universal controller. The universal controller may be operated from multiple locations, and at different periods. In one embodiment, the universal controller comprises a parent node. The universal controller may be accessible to the user over any public or private network. Prior to executing any of the service aspects of the system, the user and the universal controller have to be mutually authenticated to each other through a key server. The key server is configured to administer cryptographic key management over the system.

In some embodiments, the user interacts directly with a user interface to control the universal controller. The user interface enables a user to have precise, indirect control over the resources.

In some embodiments, the universal controller utilizes a central processing unit (CPU) to process the controllers, a real time clock (RTC) to provide time stamps, a GPS to provide location, flash memory to provide non-volatile storage of user and parent identities and nonces as well as device commands and user permissions, a near field communication (NFC) component to allow secure configuration of the local device controller, and a GSM module for global network identity.

The system provides secure access to the resources. The system also allows for control of the behavior of the resources. In one embodiment, the resources is a physical device, including, without limitation, a home, a home accessory, a door, a window, a light, a medical device, a sensor, a chemical device, a nuclear device, a vehicle, a public infrastructure, a street light, a traffic light, an industrial infrastructure, and a power plant. The access and control of the resources may be operable onsite, remotely, and over an unsecure network, such as the internet.

The system may further include at least one local device controller. The local device controller is configured to integrate into the physical device. The local device controller is configured to communicate with the universal controller, which is itself, controlled by the user. In this manner, the physical device may be accessed and manipulated onsite or remotely.

Each local device controller protects access to a correlating single resource. In some embodiments, authorized users may send commands to the local device controller to control the behavior of the resources under their control. A local device controller may be deployed anywhere on a network of resources, since the system is not limited in terms of geographical placement of managed resources. The local device controller requires only a CPU, RTC, and a small flash memory to store commands initiated at the user interface and the associated responses.

It is significant to note that, prior to the addition of the local device controller to the respective resource, the local device controller is a virgin embedded device capable of being custom configured to behave as required by the creating user. The process of adding the local device controller enables a custom state machine to be downloaded to the resource. This in turn enables the system to be used to accommodate future technological requirements.

In some embodiments, the user interface, the universal controller, the local device controller, and the key server are operable through six possible operational modules. The modules are as follows:

A resource registration module is configured to allow a new resource to be registered for operation with the other resources. In this manner, any number of resources may be integrated into the system by enabling communication between the universal controller and the local device controller.

A child node addition module is configured to allow additional local device controllers to be added to the resources. In one embodiment, each resource utilizes a single local device controller.

A child node deletion module is configured to allow excessive local device controllers that are not needed to be deleted, or operatively detached from the respective resource.

An access rights modification module is configured to assign all, or at least a subset of a user's access rights. This assignment is made through the user interface.

A user deletion module is configured to delete a user from accessing the system.

A resource actuation module is configured to actuate the resources for communication with the universal controller and normal operation.

It is one objective of the present invention to provide a communication protocol system, such as an UPACS, that enables universal control of a plurality of resources.

It is another objective to develop a common universal system that enables access to physical resource regardless of the type of physical resource and where the resources are located.

It is another objective to provide a communication protocol system that enables control of multiple resources, or physical devices, from multiple locations, such that the system can be implemented regardless of the location of the user of the resource and the location of the resource relative to the user.

It is another objective to provide a communication protocol system that accesses and controls resources onsite or remotely.

It is another objective to control the behavior of the resources over an unsecure existing networks, such as the internet and mobile phone.

Yet another objective is to provide a module to register a resource with the system.

Yet another objective is to provide a module to add a local device controller.

Yet another objective is to provide a module to delete a local device controller.

Yet another objective is to provide a module to access user rights.

Yet another objective is to provide a module to delete user access.

Yet another objective is to provide a module to actuate the resources.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a diagram of an exemplary universal controller, in accordance with an embodiment of the present invention;

FIG. 2 illustrates a diagram of an exemplary local device controller, in accordance with an embodiment of the present invention;

FIG. 3 illustrates a diagram of a communication protocol system, showing a building being protected by a system of n local device controllers, in accordance with an embodiment of the present invention;

FIG. 4 illustrates an exemplary matrix, showing the effect of addition of the local device controller to a resource, in accordance with an embodiment of the present invention;

FIG. 5 illustrates an exemplary matrix, showing the effect of access rights modification on the resource when Uz has no prior access permission for node cNodei, in accordance with an embodiment of the present invention; and

FIG. 6 illustrates a flowchart of an exemplary communication protocol method, in accordance with an embodiment of the present invention.

Like reference numerals refer to like parts throughout the various views of the drawings.

### DETAILED DESCRIPTION OF THE INVENTION

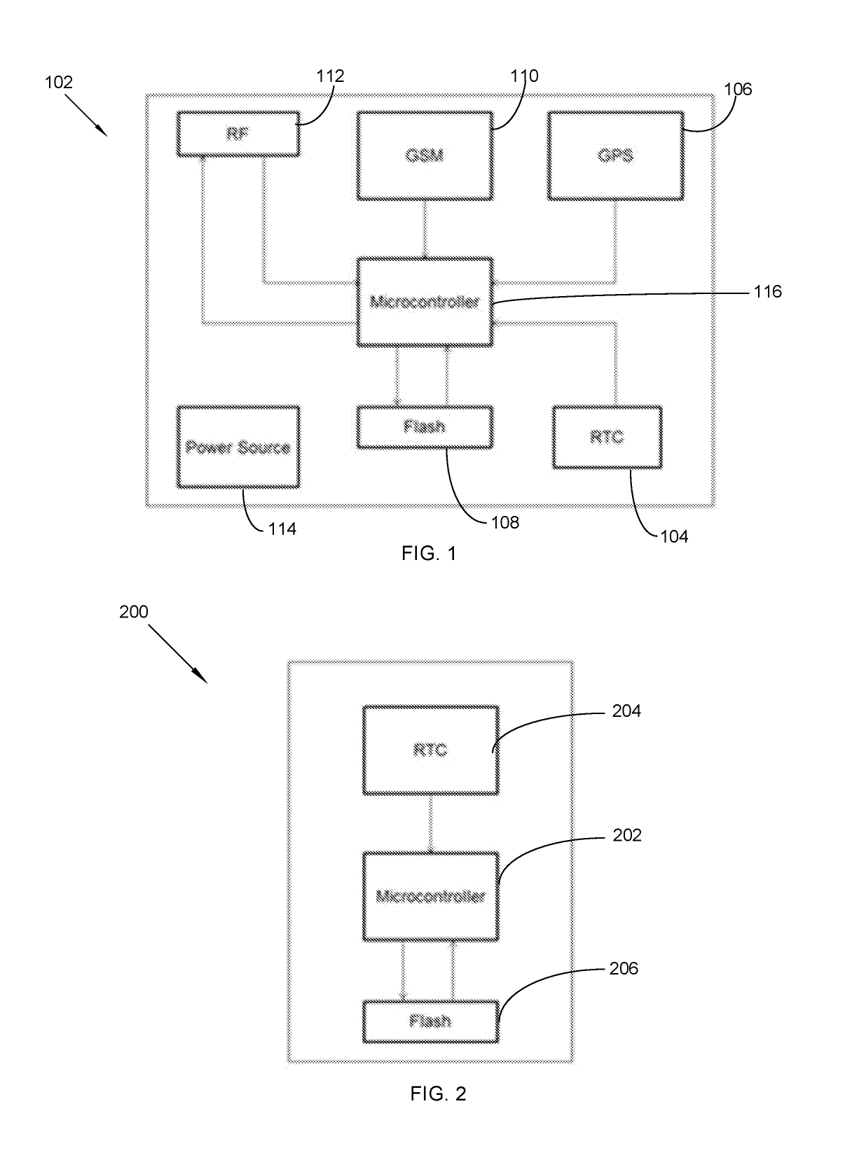

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

FIGS. 1-6 illustrate a communication protocol system 100 and method 600 for regulating access and controlling behavior of a plurality of resources (not shown) from any number of locations, onsite or remotely. The communication protocol site may include a universal physical access control system (UPACS), and an access control mechanism. The communication protocol system 100, hereafter “system 100”, allows a user to master universal access and control of a plurality of resources through operation of at least one universal controller 102. The user may utilize a user interface (not shown) to input instructions into the universal controller 102. The universal controller 102 communicates the instructions to at least one local data controller 200 that integrates into the resources. The user may control the resources from multiple locations, and the resources may also be located at multiple locations. Multiple modules create different operational phases for operation of the system.

Thus, the system 100 is effective in its universal characteristic, whereby the user may control any number of resources located at multiple locations. Those skilled in the art will recognize that by providing a universal physical device control mechanism to access and control a network of resources, scalability is created. For example, if no gas manufacturing standards were available, and all the automobile manufacturers were required to have a unique gasoline station, the efficiency of the automobile would be reduced dramatically. Another example involves the MP3 standard for music, where all music companies produce music files which are compatible with all music players. In the MP3 model, a music user, can by a song file form any music producer and play it on any music player from any manufactures.

Thus, the system 100 of the present invention helps close the gap between control applications and the thousands of resource, or physical devices and their manufacturers. The system 100 provides a new protocol on how a secured access control is operated, so that the user can buy any resource from any manufactures and still be compatible with any other controlling application product from any other manufacturer.

As referenced in FIG. 1, the system 100 enables a user to access and control a plurality of resources. The user can control the resources through manipulation of at least one universal controller 102. The universal controller 102 may be operated from multiple locations, and for different periods. In one embodiment, the universal controller 102 is a parent node. The universal controller 102 may be accessible to the user over any public or private network. Prior to executing any of the service aspects of the system 100, the user and the universal controller 102 have to be mutually authenticated to each other through a key server (not shown). The key server is configured to administer cryptographic key management over the system 100.

In some embodiments, the user interacts directly with a user interface to control the universal controller. The user interface enables a user to have precise, indirect control over the resources. The user interface may include, without limitation, a smart phone, a data entry keyboard, a display screen, a speaker, and a microphone.

Looking again at FIG. 1, a universal controller 102 utilizes a central processing unit (CPU) 116 to process the controllers 102, 200, a real time clock (RTC) to provide time stamps, a global positioning system (GPS) 106 to provide location, a flash memory 108 to provide non-volatile storage of user and parent identities and nonces as well as device commands and user permissions, a near field communication (NFC) component to allow secure configuration of the local device controller, a GSM module 110 for global network identity, a radio frequency (RF) 112 to transmit the command, and a power source 114 to provide power to the system.

The system 100 provides secure access to the resources. The system 100 also allows for control of the behavior of the resources. In one embodiment, the resources is a physical device, including, without limitation, a home, a home accessory, a door, a window, a light, a medical device, a sensor, a chemical device, a nuclear device, a vehicle, a public infrastructure, a street light, a traffic light, an industrial infrastructure, and a power plant. The access and control of the resources may be operable onsite, remotely, and over an unsecure network, such as the internet.

As shown in FIG. 2, the system 100 includes at least one local device controller 200. The local device controller 200 is configured to integrate into the physical device. The local device controller 200 is configured to communicate with the universal controller, which is itself, controlled by the user. In this manner, the resource may be accessed and manipulated onsite or remotely. In one embodiment, the local device controller 200 is a child node.

Each local device controller 200 integrates and enables access to a correlating single resource. In some embodiments, authorized users may send commands to the local device controller 200 to control the behavior of the resources under their control. The local device controller 200 may be deployed anywhere on a network of resources, since the system 100 is not limited in terms of geographical placement of managed resources. Looking again at FIG. 2, the local device controller 200 requires only a second CPU 202, a second RTC 204, and a second small flash memory 206 to store commands initiated at the user interface and the associated responses.

It is significant to note that, prior to the addition of the local device controller 200 to the respective resource, the local device controller 200 is a virgin embedded device capable of being custom configured to behave as required by the creating user. The process of adding the local device controller 200 enables a custom state machine to be downloaded to the resource. This in turn enables the system 100 to be used to accommodate future technological requirements, and also to increase scalability.

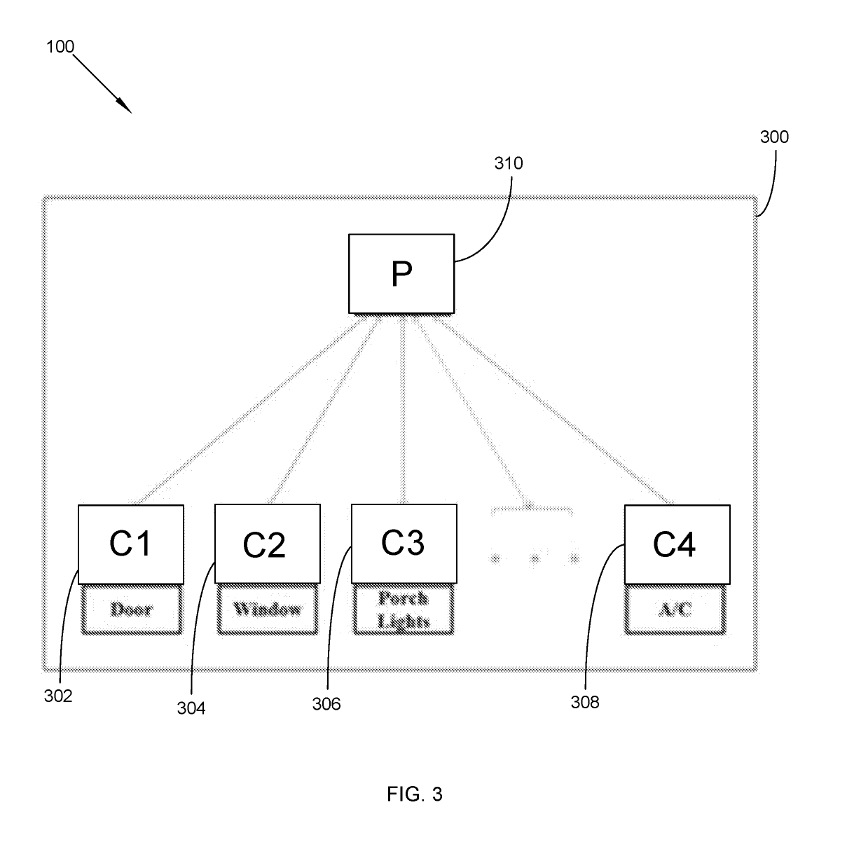

FIG. 3 illustrates a diagram of a communication protocol system 300, showing a building being protected by a system of n local device controllers. In this example, a universal controller 310 communicates separate commands to four different resources; each resource having a unique local device controller. A first local device 302 controller regulates a door. A second local device controller 304 regulates a window. A third local device 306 controller regulates a porch light. A fifth local device controller 308 regulates an air conditioner unit.

In some embodiments, the user interface, the universal controller 102, the local device controller 200, and the key server are operable through six possible operational modules described below. Through operation of the modules, all protocol phases begin with mutual authentication between the user and parent. The resource owner U₀ (which could be a person or a process) has an asymmetric key pair: a secret key skU₀ and a public key pk(sKU₀). Similarly the resource's parent node P has an asymmetric key pair: secret key skP, and public key pk(skP) which is known to U₀.

Prior to executing any of the service aspects of the protocol, users and parents have to be mutually authenticated to each other, making use of the trusted key server S. To accomplish this, the U₀ first sends a request for P's public key to key server S.

U₀→S:request(pk(skP))

S returns P's identity and public key, signed with its secret key skS:

S→U₀:sign((P,pk(skP)),skS)

U₀ generates a fresh nonce N_{U0} and sends its identity and nonce to P, encrypted with P,'s public key.

U₀→P:encrypt((U₀,N_{U0}),pk(skP))

P decrypts the message to recover U₀ and N_{U0} and sends a request to key server S for U₀ 's public key:

P→S:request(pk(sk U₀))

S returns U₀'s identity and public key, signed with its secret key skS:

S→P:sign((U₀,pk(sk U₀)),skS)

P generates a fresh nonce N_{P} and sends N_{P}, N_{U0} and its identity to U₀, encrypted with U₀ 's public key:

P→U₀:encrypt((N_{P},N_{U0},P),pk(skU₀))

U₀ decrypts the message and if the message contains its nonce it knows it is communicating with the right resource parent. It then sends back P's nonce N_{P} along with its request for additional protocol services, encrypted with its own nonce N_{U0}. When P receives and decrypts this message, if the message contains its nonce N_{P} then mutual authentication is complete and P will process the U₀ 's request, e.g.:

U₀→P:sencrypt((RREQ,N_{P}),N_{U0})

The six modules are as follows:

One module is a resource registration module. The resource registration module is configured to allow a new resource to be registered for operation with the other resources. In this manner, any number of resources may be integrated into the system by enabling communication between the universal controller and the local device controller.

From location L₀, U₀ sends parent node P's nonce N_{P} and a request for resource registration RREQ to parent node P, encrypted with its own nonce N_{U0} and waits for acknowledgment RREQ_Ack from P:

U₀→P:sencrypt((RREQ,N_{P}),N_{U0})

P→U₀:sencrypt((U₀,RREQ_Ack),N_{P})

Upon receiving P's acknowledgment RREQ_Ack U₀ sends to P its location L₀ and the current timestamp T₀, encrypted with its nonce N_{U0}.

U₀→P:sencrypt((L₀,T₀),N_{U0})

P decrypts the message with U₀ 's nonce to retrieve L₀ and T₀, which it then uses to compute its resource identity ResourceID by encrypting L₀, T₀ and N_{U0} with its own nonce N_{P}.

P registers U₀ as the owner of resource ResourceID, stores its identity ResourceID in persistent memory and sends ResourceID and confirmation of successful registration RREQ_Confirm to U₀, encrypted with N_{P}.

P→U₀:sencrypt((RREQ,RREQ_Confirm,ResourceID),N_{P})

U₀ decrypts the message with N_{P} to recover RREQ_Confirm and ResourceID, which it records as the identity of the newly registered resource.

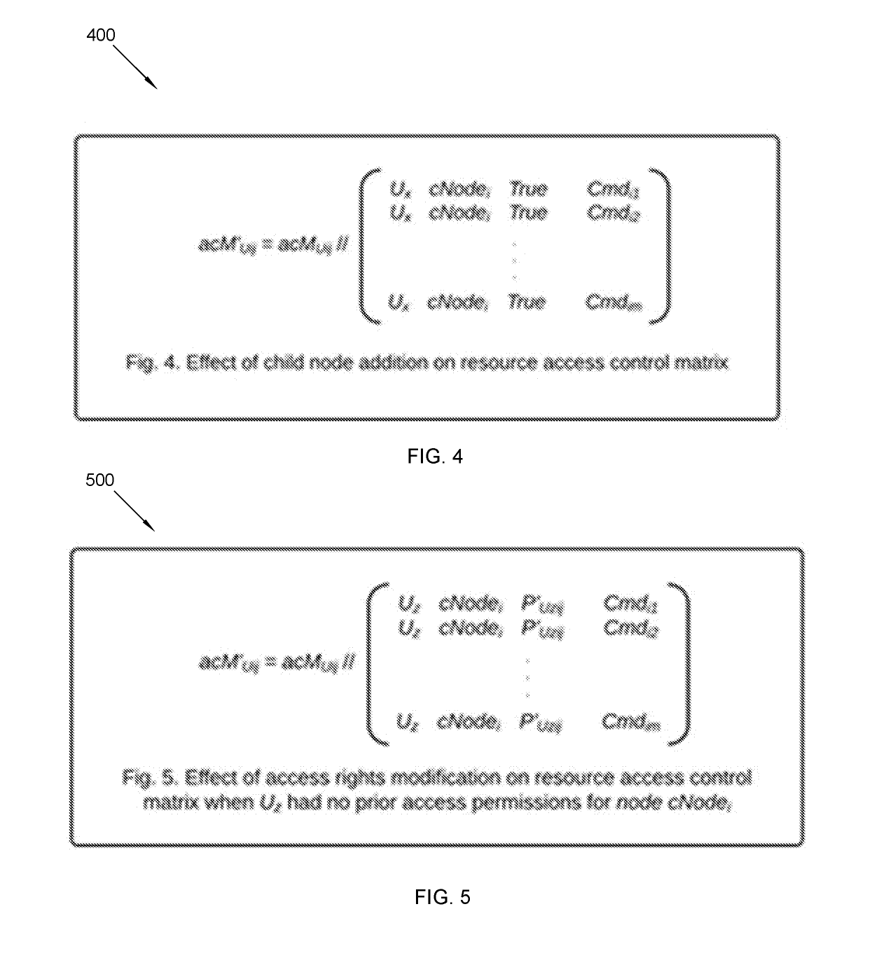

In another module, a child node addition module is configured to allow additional local device controllers to be added to the resources. In one embodiment, each resource utilizes a single local device controller. FIG. 4 illustrates an exemplary matrix 400, showing the effect of addition of the local device controller to a resource.

In one embodiment, as many child nodes C_{i, i>0} as are required may be added to a resource after its parent node P has been initialized with its secret identity ResourceID. Each child node Cᵢ can be located anywhere a network connection can be established between itself and P. Any user Uₓ may attempt to add a child node Cᵢ as follows:

Uₓ sends parent node P's nonce N_{P} and a request for child node addition AREQ to parent node P, encrypted with its own nonce N_{U0} and waits for acknowledgment AREQ_Ack from P:

Uₓ→P:sencrypt((AREQ,N_{P}),N_{Ux})

P→Uₓ:sencrypt((Uₓ,AREQ_Ack),N_{P})

Upon receiving P's acknowledgment AREQ_Ack Uₓ sends to P the resource's identity ResourceID encrypted with its nonce N_{Ux}. Uₓ also sends to P all the data necessary to initialize the new child node

Uₓ→P:sencrypt((ResourceID),N_{Ux})

Ux→P:sencrypt((PermUxij=True,Cmdij,Actij),N_{Ux}), j>0 for all
commands j that child node Ci can execute, where Perm Uxij is the Boolean permission of user Ux to issue command Cmdij and Actij is the action that child node Ci will perform upon receiving command Cmdij.

P decrypts the messages with Uₓ's nonce to retrieve ResourceID and all node initialization data (Perm_{Uxij}, Cmdᵢⱼ, Actᵢⱼ), j>0 and if Uₓ is the registered owner of ResourceID then P generates a new random child node identity cNodeᵢ to be the identity of the new child node Cᵢ and initializes Cᵢ with all (Perm_{Uxij}, Cmdᵢⱼ, Actᵢⱼ), j>0.

P then sends ResourceID, cNodeᵢ and confirmation of successful child node addition AREQ_Confirm to Uₓ, encrypted with N_{P}.

P→Uₓ:sencrypt((AREQ,AREQ_Confirm,ResourceID,cNodeᵢ),N_{P})

P also adds a row for each command Cmd_{ij, j>0} to the resource's access control matrix acM_{Uij}=[U_{x,x>0} cNode_{i,i>0} Perm_{Uxij,i>0,j>0} Cmd_{ij,i>0, j>0}]:

[Uₓ cNodeᵢ Perm_{Uxij}=True Cmdᵢⱼ]

For commands Cmd_{ij,j=l,m}. P computes the resource's new access control matrix acM′_{Uij} by vertically concatenating rows [Uₓ cNodeᵢ Perm_{Uxij}=True Cmdᵢⱼ] to acM_{Uij} as in FIG. 4.

Uₓ decrypts the message with N_{P} to recover AREQ_Confirm, ResourceID and cNodeᵢ, which it records as the identity of the new child node

In another module, a child node deletion module is configured to allow excessive local device controllers that are not needed to be deleted, or operatively detached from the respective resource.

Any child node Cᵢ may be deleted by the registered owner of the resource to which it belongs. It may not be deleted by any other user. Any user Uₓ may attempt to delete a child node as follows:

Uₓ sends parent node P's nonce N_{P} and a request for child node deletion DREQ to parent node P, encrypted with its own nonce N_{U0} and waits for acknowledgment DREQ_Ack from P:

Uₓ→P:sencrypt((DREQ,N_{P}),N_{Ux})

P→Uₓ:sencrypt((Uₓ,DREQ_Ack),N_{P})

Upon receiving P's acknowledgment DREQ_Ack Uₓ sends to P the resource's identity ResourceID and the identity of the child node to be deleted cNodeᵢ, encrypted with its nonce N_{Ux}.

Uₓ→P:sencrypt((ResourceID,cNodeᵢ),N_{Ux})

P decrypts the message with Uₓ's nonce to retrieve ResourceID and cNodeᵢ, and deletes the node if cNodeᵢ belongs to resource ResourceID and Uₓ is the registered owner of resource ResourceID.

P removes all rows [X=cNodeᵢ X X] from the resource's access control matrix acM_{Uij}.

[X=cNodeᵢ X X]=[ ].

P then sends ResourceID, cNodeᵢ and confirmation of successful child node deletion DREQ_Confirm to Uₓ, encrypted with N_{P}.

P→Uₓ:sencrypt((DREQ,DREQ_Confirm,ResourceID,cNode),N_{P})

Uₓ decrypts the message with N_{P} to recover DREQ_Confirm, ResourceID and cNodeᵢ, which it records as being deleted.

In another module, an access rights modification module is configured to assign all, or at least a subset of a user's access rights. This assignment is made through the user interface. FIG. 5 illustrates an exemplary matrix 500, showing the effect of access rights modification on the resource when Uz has no prior access permission for node cNodeᵢ. In one embodiment, any user Uₓ may transfer all or any subset of his resource access rights to another user U_{z} subject to the prior access permissions of both Uₓ and U_{z}.

Rights transfers done on any given child node Cᵢ do not affect Uₓ's permissions Perm_{Uxij} to issue any of the j commands that can be issued to child node Cᵢ. However, U_{z}'s permission Perm_{Uzij} to issue any given command Cmdᵢⱼ to child node Cᵢ will be updated by the request. Neither Uₓ nor U_{z} has to be the owner of the resource to which child node Cᵢ belongs.

User Uₓ may attempt to transfer all or a subset of his access permissions Perm_{Uxij} for child node Cᵢ to user U_{z} as follows:

Uₓ sends parent node P's nonce N_{P} and a request for access rights modification TREQ to parent node P, encrypted with its own nonce N_{U0} and waits for acknowledgment TREQ_Ack from P:

Uₓ→P:sencrypt((TREQ,N_{P}),N_{Ux})

P→Uₓ:sencrypt((Uₓ,TREQ_Ack),N_{P})

Upon receiving P's acknowledgment TREQ_Ack Uₓ sends to P the resource's identity ResourceID, the identity of the child node to be affected by the transfer cNodeᵢ and the user to which the rights transfer is intended U_{z}, encrypted with its nonce N_{Ux}. Uₓ also sends to P the j child node commands Cmdᵢⱼ of child node Cᵢ to be affected by the transfer and the requested permissions Rᵢⱼ for U_{z} to issue commands Cmdᵢⱼ.

Uₓ→P:sencrypt((ResourceID,cNodeᵢ,U_{z}),N_{Ux})

Ux→P:sencrypt((Rij,Cmdij),NUx), j>0 for all commands j that child node Ci can execute, where Rij is the requested Boolean permission of user Uz to issue command Cmdij.

P decrypts the message with Uₓ's nonce to retrieve ResourceID, cNodeᵢ, and U_{z}, retrieves from storage all of Uₓ's cNodeᵢ permissions Yᵢⱼ and any prior U_{z} permissions Zᵢⱼ for cNodeᵢ, and computes the new permissions P′_{Uzij} for U_{z} to issue commands Cmdᵢⱼ to Cᵢ as:

P′_{Uzij}=YᵢⱼRᵢⱼ+Zᵢⱼ

If U_{z} had prior Cᵢ access permissions Zᵢⱼ, P updates the resource's access control matrix acM_{Uij} for all rows [=U_{z}=cNodeᵢ Zᵢⱼ=Cmdᵢⱼ] to [=U_{z}=cNodeᵢ P′_{Uzij}=Cmdᵢⱼ].

If U_{z} had no prior Cᵢ access permissions, for commands Cmd_{ij, j=l,m} P computes the resource's new access control matrix acM′_{Uij} by vertically concatenating rows [U_{z} cNodeᵢ P′_{Uzij} Cmdᵢⱼ] to acM_{Uij} as in FIG. 5.

In another module, a user deletion module is configured to delete a user from accessing the system.

The permissions of any user U_{z} to issue commands to a child node Cᵢ with identity cNodeᵢ may be revoked by the owner of the resource to which Cᵢ belongs in a process called user deletion. Only the resource owner may delete a user. A resource owner Uₓ may delete a user U_{z} as follows:

Uₓ sends parent node P's nonce N_{P} and a request for user deletion DUSR to parent node P, encrypted with its own nonce N_{U0} and waits for acknowledgment DUSR_Ack from P:

Uₓ→P:sencrypt((DUSR,N_{P}),N_{Ux})

P→Uₓ:sencrypt((Uₓ,DUSR_Ack),N_{P})

Upon receiving P's acknowledgment DUSR_Ack Uₓ sends to P the resource's identity ResourceID, the identity cNodeᵢ of the child node to be affected by the deletion, and the user to be deleted U_{z}, encrypted with its nonce N_{Ux}.

Uₓ→P:sencrypt((ResourceID,cNodeᵢ,U_{z}),N_{Ux})

P decrypts the message with Uₓ's nonce to retrieve ResourceID, cNodeᵢ, and U_{z}, and deletes the user if cNodeᵢ belongs to resource ResourceID and Uₓ is the registered owner of resource ResourceID.

P removes all rows [=U_{z}=cNodeᵢ X X] from the resource's access control matrix acM_{Uij}:

[=U_{z}=cNodeᵢ X X]=[ ].

P then sends ResourceID, cNodeᵢ, U_{z} and confirmation of successful user deletion DUSR_Confirm to Uₓ, encrypted with N_{P}.

P→Uₓ:sencrypt((DUSR,DUSR_Confirm,ResourceID,cNodeᵢ,U_{z}),N_{P})

Uₓ decrypts the message with N_{P} to recover DUSR_Confirm, ResourceID, cNodeᵢ, and U_{z} and records U_{z} as being deleted with regard to cNodeᵢ.

In another module, a resource actuation module is configured to actuate the resources for communication with the universal controller and normal operation.

Any user Uₓ with may issue commands Cmdᵢⱼ to any child node Cᵢ and Cᵢ will process the command if Uₓ's permission to issue command Cmdᵢⱼ is set to True. The process for issuing commands to a child node is as follows:

Uₓ sends parent node P's nonce N_{P} and a request for child node actuation ACTC to parent node P, encrypted with its own nonce N_{U0} and waits for acknowledgment ACTC_Ack from P:

Uₓ→P:sencrypt((ACTC,N_{P}),N_{Ux})

P→Uₓ:sencrypt((Uₓ,ACTC_Ack),N_{P})

Upon receiving P's acknowledgment ACTC_Ack Uₓ sends to P the resource's identity ResourceID and the identity cNodeᵢ of the child node to be actuated, encrypted with its nonce N_{Ux}. Uₓ also sends to P one or more commands CmdReqᵢⱼ for child node Cᵢ.

Uₓ→P:sencrypt((ResourceID,cNodeᵢ),N_{Ux})

Uₓ→P:sencrypt((CmdReqᵢⱼ),N_{Ux}), j>0

P decrypts the messages with Uₓ's nonce to retrieve ResourceID, cNodeᵢ and all commands to be executed CmdReqᵢⱼ, j>0 and for each command CmdReqᵢⱼ if CmdReqᵢⱼ is a valid command for node cNodeᵢ and Uₓ has permission of True for command CmdReqᵢⱼ then P sends command CmdReqᵢⱼ to cNodeᵢ for execution.

P then sends ResourceID, cNodeᵢ and confirmation of successful command delivery ACTC_Confirm to Uₓ, encrypted with N_{P}.

P→Uₓ:sencrypt((ACTC,ACTC_Confirm,ResourceID,cNodeᵢ),N_{P})

Uₓ decrypts the message with N_{P} to recover ACTC_Confirm, ResourceID and cNodeᵢ.

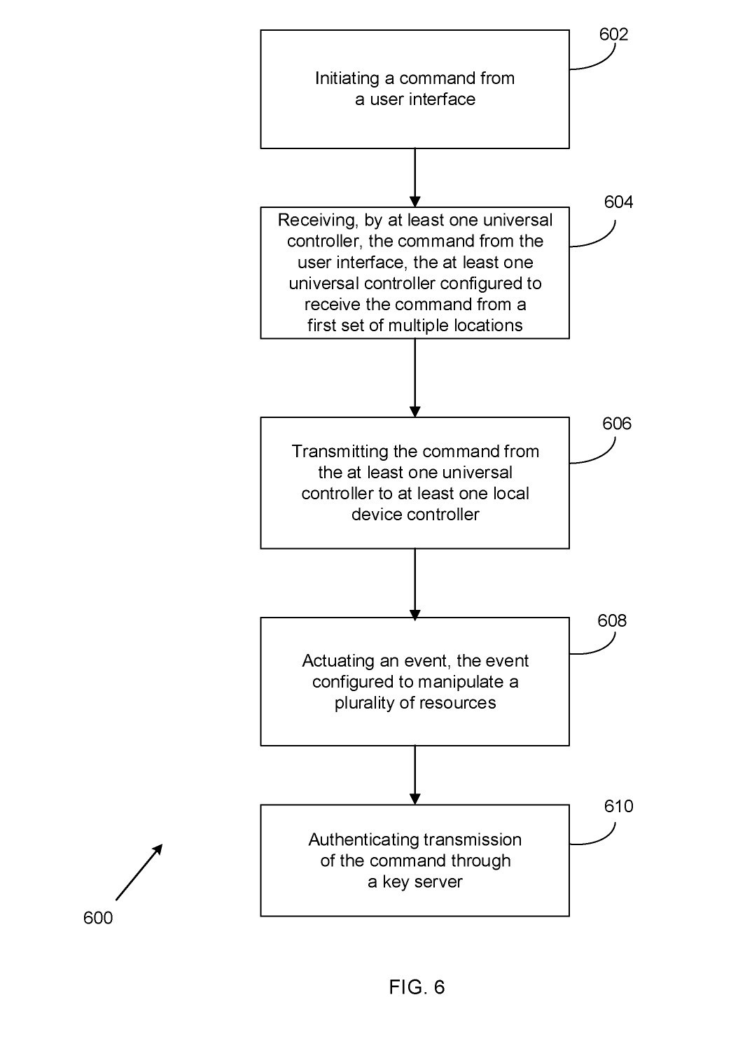

FIG. 6 illustrates a flowchart of an exemplary communication protocol method 600. The method 600 includes an initial Step 602 of initiating a command from a user interface. A Step 604 may include receiving, by at least one universal controller, the command from the user interface, the at least one universal controller configured to receive the command from a first set of multiple locations.

In some embodiments, a Step 606 may include transmitting the command from the at least one universal controller to at least one local device controller. A Step 608 includes actuating an event, the event configured to manipulate a plurality of resources. A final Step 610 comprises authenticating transmission of the command through a key server.

In conclusion, the present invention utilizes a Universal Physical Access Control System (UPACS), which provides a universal framework for controlling access to physical resources. The system provides for the use of a wide variety of access devices and allows for both onsite and remote access. The system can be used to control access to any type of resource, including homes, vehicles and public infrastructure such as street lights and traffic lights and industrial infrastructure such as power plants. The system can also be implemented regardless of the location of the owner of the physical resource and the location of the resource relative to its users.

These and other advantages of the invention will be further understood and appreciated by those skilled in the art by reference to the following written specification, claims and appended drawings.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A communication protocol system, the system comprising:
a user interface, the user interface configured to initiate a command;
at least one universal controller, the at least one universal controller configured to receive the command from the user interface, the at least one universal controller further configured to transmit the command while disposed in a plurality of locations;
at least one local device controller, the at least one local device controller configured to receive the command from the at least one universal controller, the at least one local device controller further configured to create an event in response to the command, the at least one local device controller further configured to receive the command while disposed in the plurality of locations;
a plurality of resources, the plurality of resources configured to operatively join with the at least one local device controller, the plurality of resources further configured to be manipulated in response to the event created by the at least one local device controller;
a key server, the key server configured to authenticate transmission of the command;
a resource registration module, the resource registration module configured to register the plurality of resources with the system;
a child node addition module, the child node addition module configured to add the at least one local device controller to the plurality of resources;
a child node deletion module, the child node deletion module configured to remove the at least one local device controller from the plurality of resources;
an access rights modification module, the access rights modification module configured to assign at least partial rights to enable use of the system;
a user deletion module, the user deletion module configured to restrict initiation of the command; and
a resource actuation module, the resource actuation module configured to actuate the plurality of resources.

2. The system of claim 1, wherein the system comprises a universal physical access control system.

3. The system of claim 1, wherein the user interface is configured to receive the command from a user.

4. The system of claim 1, wherein the at least one universal controller comprises at least one parent node.

5. The system of claim 1, wherein the at least one local device controller comprises at least one child node.

6. The system of claim 1, wherein the at least one child node is configured to create a control system by integrating into a residential building house, an office, and a factory, whereby the at least one child node is controlled by the at least one parent node.

7. The system of claim 1, wherein the at last one parent node and the at least one child node are configured to be manufactured by a production company if the at last one parent node and the at least one child node are integrated into the system.

8. The system of claim 1, wherein the at last one parent node and the at least one child node are configured to communicate through the key server that is operable on a cloud server, whereby authentication of the communication is secured before the event is requested by the at least one parent node and executed by the at least one child node.

9. The system of claim 1, wherein the plurality of resources includes at least one member selected from the group consisting of: a home, a home accessory, a door, a window, a light, a medical device, a sensor, a chemical device, a nuclear device, a vehicle, a public infrastructure, a street light, a traffic light, an industrial infrastructure, and a power plant.

10. The system of claim 1, wherein the key server is configured to administer cryptographic key management over transmission of the command.

11. The system of claim 1, wherein the at least one universal controller includes at least one member selected from the group consisting of: a central processing unit, a real time clock, a global positioning system, a flash memory, a near field communication, a global network identity module, and a power source.

12. The system of claim 1, wherein the at least one local device controller includes at least one member selected from the group consisting of: a second central processing unit, a second real time clock, and a second flash memory.

13. A communication protocol method, the method comprising:
initiating a command from a user interface;
receiving, by at least one universal controller, the command from the user interface, the at least one universal controller configured to receive the command from a first set of multiple locations;
transmitting the command from the at least one universal controller to at least one local device controller;
actuating an event, the event configured to manipulate a plurality of resources; and
authenticating transmission of the command through a key server.

14. The method of claim 13, further including a step of registering the plurality of resources.

15. The method of claim 13, further including a step of adding the at least one local device controller to the plurality of resources.

16. The method of claim 13, further including a step of removing the at least one local device controller from the plurality of resources.

17. The method of claim 13, further including a step of assigning at least partial rights to enable use of the system.

18. The method of claim 13, further including a step of restricting utilization of the system.

19. The method of claim 13, further including a step of restricting utilization of the system comprises deleting a user.

20. The method of claim 13, further including a step of actuating the plurality of resources.
